(19) United States
(12) Patent Application Publication
(10) Pub. No.: US 2012/0033727 A1
(43) Pub. Date: Feb. 9, 2012

(54) EFFICIENT VIDEO CODEC IMPLEMENTATION

(75) Inventors: GADI SHOR, Tel Aviv (IL); SHANI DICHTER, Kfar Saba (IL); DROR HAR HEN, Raanana (IL); SORIN GOLDENBERG, Nes Ziona (IL); DAVID MESHULAM, Hod Hasharon (IL)

(73) Assignee: WISAIR LTD., TEL AVIV (IL)

(21) Appl. No.: 13/204,736

(22) Filed: Aug. 8, 2011

Related U.S. Application Data
(60) Provisional application No. 61/371,746, filed on Aug. 9, 2010.

(51) Int. Cl. H04N 7/12

(52) U.S. Cl. 375/240.02; 375/E07.126

(57) ABSTRACT

A device and a method are provided. The device may include: a first encoder arranged to apply a first type encoding process on an input frame element to provide a first type encoded frame element; the input frame elements belong to an input frame; a second encoder arranged to apply a second type encoding process on the input frame element to provide a second type encoded frame element; wherein the first type encoding process differs from the second type encoding process by a degree of expected loss of data; a control circuit arranged to select a selected frame element out of the first and second type encoded frame elements; a memory unit arranged to store information about the selected frame element; and an output interface arranged to output the selected frame element.

### RELATED APPLICATIONS

This application claims priority of US provisional patent serial number 61/371746, filing date Aug. 9, 2010 which is incorporated herein by reference.

### BACKGROUND

Wireless video is becoming part of many applications and use cases including Lap-top to TV, Laptop to projector, High Definition Multimedia Interface (HDMI) cable replacement, tablets, touch-panels and many other applications. The goal is to support high resolution (e.g. 1920×1080 and higher, 3D content, etc.), high frames per second (e.g. 30, 60 and higher frames per second), low latency and high quality with low cost and low power consumption implementation.

State of the art solutions for high resolution, high frames per second and high quality wireless video require large amount of high access speed memories to deliver reliable wireless video experience over the air.

### SUMMARY

A device can be provided according to an embodiment of the invention and may include: a first encoder arranged to apply a first type encoding process on an input frame element to provide a first type encoded frame element; the input frame elements belong to an input frame; a second encoder arranged to apply a second type encoding process on the input frame element to provide a second type encoded frame element; wherein the first type encoding process differs from the second type encoding process by a degree of expected loss of data; a control circuit arranged to select a selected frame element out of the first and second type encoded frame elements; a memory unit arranged to store information about the selected frame element; and an output interface arranged to output the selected frame element.

A method for encoding can be provided and may include: applying, by a first encoder, a first type encoding process on an input frame element to provide a first type encoded frame element; the input frame elements belong to an input frame; applying, by a second encoder, a second type encoding process on the input frame element to provide a second type encoded frame element; wherein the first type encoding process differs from the second type encoding process by a degree of expected loss of data; selecting, by a control circuit, a selected frame element out of the first and second type encoded frame elements; storing, by a memory unit, information about the selected frame element; and outputting the selected frame element.

The memory unit may be arranged to store the information about the selected frame element while not storing the input frame.

The first type encoding process may be a lossless type encoding process and wherein the second type encoding process may be a lossy type encoding process.

The input frame element may be located at a certain location of the input frame; wherein the control circuit may be arranged to select the selected frame element based upon an amount of temporal changes associated with the certain location.

The input frame element may be arranged to select the first type encoded frame element if the certain location may be associated with static content.

The control circuit may be arranged to change encoding parameters for different input frame elements that belong to different locations of the input frame in response to changes in an overall bit rate allocated to the input frame and in response to the amount of temporal changes associated with the different locations.

The control circuit may be arranged to change the encoding parameters while prioritizing input frame elements that belong to locations of the input frame that are more static than other locations of the frames.

The control circuit may be arranged to select the first type encoded frame element if the first type encoded frame element may be smaller than the second type encoded frame element.

The control circuit may be arranged to select the first type encoded frame element if a size difference between the first type encoded frame element and the second type encoded frame element may be below a size threshold.

The second encoder may be arranged to perform a downsizing format conversion of the input frame element to provide a format converted frame element; wherein the control circuit may be arranged to select the selected frame element based on a relationship between (a) the input frame element and (b) a reconstructed frame element; and wherein the reconstructed frame element may be generated by applying an upsizing format conversion on the format converted frame element, wherein the reconstructed frame element has a same format as the input frame element.

The control circuit may be arranged to select, for each of the first encoder and second encoder, a selected quality level of encoding out of multiple allowable quality levels. If, for example, the first encoder is a lossless encoder than the levels of quality can be selected from the second encoder.

The device may include a skip circuit that may be arranged to: perform a comparison between (i) information about a current set, wherein the current set that comprises at least one selected frame elements that belong to the input frame, and (ii) information about a previous set, wherein the previous set that comprises at least one previously selected frame element that belongs to a previous frame but of the same location; and determine, based on a result of the comparison, whether the output interface shall output the current set or be prevented from outputting the current set.

The first type encoding process may be a lossless type encoding process and wherein the second type encoding process may be a lossy type encoding process.

The skip circuit may be arranged to perform the comparison between the current set and the previous set.

The skip circuit may be arranged to perform a comparison between (i) at least one hash value of the at least one selected frame element of the current set and (ii) at least one hash value of the at least one previously selected frame element.

The memory unit may be arranged to store hash values of frame elements of previous frames and may be prevented from storing the frame elements of the previous frames.

The current set may be a slice of the input frame and wherein the previous set may be a slice of a previous frame that may be located at a same location; wherein the skip circuit may be arranged to determine whether the output interface will output the slice of the input frame or to transmit skip information indicative of a determination not to output the slice of the input frame.

The skip circuit may be arranged to send to the output interface skip information indicative of a determination not to transmit the current set.

The device may include a decoder that may be arranged to: partially decode the current set to provide the information about the current set; and partially decode the previous set to provide the information about the previous set.

The decoder may be arranged to partially decode the current set to provide a frequency domain representation of the current set.

The decoder may be arranged to fully decode the current set to provide the information about the current set; and fully decode the previous set to provide the information about the previous set.

The device may be arranged to determine whether the output interface should output the current set or difference information indicative of a difference between the current set and the previous set.

The device may include a skip circuit that may be arranged to detect that the input frame and at least one previous frame form a sequence of frames that are equal to each other; and to allocate multiple frame transmission periods to a transmission of one frame of the sequence of frames.

The device may include a skip circuit that may be arranged to detect that the input frame and at least one previous frame form a sequence of frames that are equal to each other; to analyze one frame of the sequence of frames to provide an analysis result and to determining at least one encoding parameter based on the analysis result.

The skip circuit can be arranged to detect that the selected frame element and at least one previous selected frame element of a same location form a sequence of selected frame elements frames that are equal to each other; and to allocate multiple frame element transmission periods to a transmission of one frame element of the sequence of frame elements.

The skip circuit can be arranged to detect that the selected frame element and at least one previous selected frame element of a same location form a sequence of selected frame elements frames that are equal to each other; and to analyze one selected frame element of the sequence of selected frame elements to provide an analysis result and to determining at least one encoding parameter based on the analysis result.

According to an embodiment of the invention a device may be provided and may include: an encoder arranged to encode an input frame portion to provide a currently encoded frame portion, the input frame portion belongs to an input frame; a memory unit that may be arranged to store information about the currently encoded frame portion and about a corresponding previously encoded frame portion, without storing a input frame portion and without storing a portion of a previous frame, wherein the corresponding previously encoded frame portion may be generated from the portion of the previous frame; wherein the corresponding previously encoded frame portion may be located at a certain location of the previous frame, and wherein the currently encoded frame portion may be located at the certain location of the input frame; a skip circuit that may be arranged to: perform a comparison between information about the currently encoded frame portion and information about the previously encoded frame portion; and determine, based on a result of the comparison, whether the device shall output the currently encoded frame portion or information indicative of a determination to skip a transmission of the currently encoded frame portion.

The skip circuit may be arranged to perform a comparison between (i) at least one hash value of the currently encoded frame portion and (ii) at least one hash value of the at least one previously selected frame element.

The memory unit may be arranged to store hash values of previously encoded frame portions and may be prevented from storing previously received input frame portions that were encoded to provide the previously encoded frame portion.

The device may include a decoder that may be arranged to: partially decode the currently encoded frame portion to provide the information about the currently encoded frame portion; and partially decode the previously encoded frame portion to provide the information about the previously encoded frame portion.

The decoder may be arranged to partially decode the currently encoded frame portion to provide a frequency domain representation of the currently encoded frame portion.

The device may include a decoder that may be arranged to: fully decode the currently encoded frame portion to provide the information about the current set; and fully decode the previously encoded frame portion to provide the information about the previously encoded frame portion.

The device may be arranged to determine whether the output interface should output the currently encoded frame portion or difference information indicative of a difference between the currently encoded frame portion and the previously encoded frame portion.

According to an embodiment of the invention a method for encoding may be provided and may include: encoding, by an encoder , an input frame portion to provide a currently encoded frame portion, the input frame portion belongs to an input frame; storing, by a memory unit, a previously encoded frame portion without storing a previous frame, wherein the previously encoded frame portion may be generated from a portion of the previous frame; wherein the previously encoded frame portion may be located at a certain location of the previous frame, and wherein the currently encoded frame portion may be located at the certain location of the input frame; performing, by a skip circuit, a comparison between information about the currently encoded frame portion and information about the previously encoded frame portion; and determining, based on a result of the comparison, whether the device shall output the currently encoded frame portion or information indicative of a determination to skip a transmission of the currently encoded frame portion.

Any of the above methods can include receiving encoded frame information over a channel, and reconstructing the encoded frame; wherein the reconstructing comprises performing a decoding process while utilizing a memory unit that stores previously received encoded frame elements without storing previously reconstructed frame elements.

According to an embodiment of the invention a method for decoding is provided and may include decoding, by an decoder, an encoded frame element to provide a reconstructed frame element; and storing, by a memory unit, a previously received encoded frame element without storing a previously decoded frame element that was generated by decoding the previously received encoded frame element.

The decoding may be responsive to skip information indicative of a determination, by a transmitter, to skip a transmission of a current set of selected frame elements.

The decoding may be responsive to encoding information that reflects a manner in which the encoded frame element was encoded.

The decoding may be responsive to encoding information indicative of a type of encoding selected from lossless encoding and lossy encoding.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a device according to an embodiment of the invention;

FIG. 2 illustrates a device according to an embodiment of the invention;

FIG. 3 illustrates a device according to an embodiment of the invention;

FIG. 4 illustrates a device according to an embodiment of the invention;

FIG. 5 illustrates a device according to an embodiment of the invention;

FIG. 6 illustrates a device according to an embodiment of the invention;

FIG. 7 illustrates a device according to an embodiment of the invention;

FIG. 8 illustrates a method according to an embodiment of the invention;

FIG. 9 illustrates a method according to an embodiment of the invention;

FIG. 10 illustrates a method according to an embodiment of the invention;

FIG. 11 illustrates a method according to an embodiment of the invention;

FIG. 12 illustrates a screen of a computer according to an embodiment of the invention;

FIG. 13 illustrates a device according to an embodiment of the invention; and

FIG. 14 illustrates a method according to an embodiment of the invention.

### DETAILED DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views.

Because the illustrated embodiments of the present invention may for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

There are provided devices and methods for supporting high resolution, high frame per second and high quality wireless/wired video transmission (e.g. Ultra Wide Band, WiFi, Universal Serial Bus, Ethernet, Coax, etc.) using low cost and low power consumption implementation.

One of the main factors that increases the power consumption and the cost of prior art system is the size of memory space and the speed of memory units required for handling the encoding, decoding processes.

There are provided devices and methods in which video frame are kept in the compressed domain. This is contrary to various prior art solutions that store uncompress copies of previous video frames to carry out various inter-frame operations such as difference calculation and last frame presentation operation. Storing compressed (encoded) frame dramatically reduces the required memory space allocated for storing such video frames. Thus, smaller (and optionally faster) memory units can be used. These smaller memory units can consume less power than memory units that are designed to store video frames in uncompressed format. This allows the use of smaller memories with lower access speed and lower power consumption by an order of magnitude.

There are several methods to implement the wireless video system while keeping the previous video frame(s) in the compressed domain. The following is a description of several concepts which can be used as part of the implementation to trade off performance and complexity. The different concepts can be implemented using old and new video encoders (e.g. MJPEG, MPEG-2, H.264).

Skipping a Transmission of a Frame Element

A device can include an encoder that may divide a frame (input frame) to multiple slices (each slice is made out of one or more macro-blocks). The incoming slice is encoded and compared to the compressed data of one or more corresponding slice of a previous frame. If the data in the compressed domain is the same as the encoded incoming slice then data transmission can be skipped. This operation reduces the required bandwidth especially for the static parts of the video frame (e.g. background, computer desk-top, etc.) without the need to keep an uncompressed copy of the previous frame(s).

The device can include a decoder that may build the next compressed frame using the compressed data from the previous frames and the new received compressed data. The decoder is able to decode in real-time and present the last frame on the screen.

Both encoder and decoder can use small amount of memory with low access speed. To further minimize the amount of memory in the encoder, it is possible to keep a hash value per slice instead of the complete compressed slice and compare the hash value of the incoming encoded slice to the hash value kept in the memory. If the values are the same data transmission is skipped.

Skipping Based on Difference in the Frequency Domain

A device can include an encoder that can be arranged to partially decode a previous compressed video slice to regenerate the frequency domain samples (i.e. the lossless decoding is implemented). An incoming slice is partially decoded up to the frequency domain. The two slices are subtracted from each other and a lossless encoding is performed on both the frequency domain incoming data and on the frequency domain difference. If the encoded difference slice is smaller than the encoded incoming slice the encoded difference is sent over the air otherwise the incoming encoded slice is sent over the air. If the difference is below a threshold and/or is equal to zero, slice transmission can be skipped. The incoming encoded slice is kept to serve as the previous compressed frame. Other methods can be used to decide if the transmitted slice should be the incoming compressed slice or the difference slide (e.g. measurement of the sum of absolute differences in the frequency domain).

The device can include a decoder. If an incoming slice was transmitted the decoder uses it to build the new compressed frame. If the slice was skipped the decoder uses the previous compressed slice as part of the new compressed frame. If the difference was transmitted the decoder partly decodes the previous compressed slice (i.e. the lossless decoding is implemented) add the received difference slice and partially encode it to create the new compressed frame. The decoder is able to decode in real-time and present the last frame on the screen.

Skipping Based on the Difference in the Pixel Domain

The device can include an encoder. The previous compressed video slice is fully decoded to regenerate the pixels. The incoming slice is subtracted from to the previous slice. A full encoding is performed on both the incoming data and on the difference in the pixel domain. If the encoded difference slice is smaller than the encoded incoming slice the encoded difference is sent over the air, otherwise the incoming encoded slice is sent over the air. If the difference is below a threshold and/or is equal to zero, slice transmission can be skipped. The incoming encoded slice is kept to serve as the previous compressed frame. Other methods can be used to decide if the transmitted slice should be the incoming compressed slice or the difference slide (e.g. measurement of the sum of absolute differences in the pixel domain).

The concepts above are very efficient over a wide bandwidth link (e.g. UWB) which allows simple encoding/decoding (e.g. Discrete Cosine Transform+Quantization+lossless encoding) for a given quality but can also be used with more sophisticated encoding/decoding techniques (e.g. local motion estimation, etc.).

The concepts above can be implemented in hardware (HW), software (SW) or combination between HW and SW. The implementation can be done in both the encoder and decoder. The implementation can also be used in one side only (encoder or decoder) while the other side is based on state off the art implementation in the uncompressed domain.

The concepts can be implemented in systems with sub-frame latency and in systems with multiple frames latency including system in which latency is changed dynamically according to channel conditions

The compress domain buffer can keep one frame or multiple frames to serve as reference for the encoding/decoding process.

The implementation can be done using a single encoder running at a faster clock or multiple encoder modules running at the interface clock.

If the frame is full of changes relative to the previous frame and the amount of data needed to transmit the frame is bigger than a threshold, the frame can be transmitted over a period of more than one frame while skipping the next frame(s) this frame can than serve as the reference for the next frames in the scene allowing high quality frames even under limited channels and/or bad channel conditions.

For content which appears multiple times on the interface (e.g. in 24 frames over a 60 frames per second video interface the same frame is sent multiple times over the video interface). The redundant first frame can be used for a first pass on the information without transmission and the results of the first pass can be used for deciding on the encoding parameters of the second frame during the second pass (quality metrics, maximum number of bits per macro block, etc.). This allows a two pass operation without having to keep a complete uncompressed frame in the encoder memory.

Under combinations of static and dynamic content on the screen (e.g. movie in the middle of an internet page) two or more Q metrics can be used as addition to simple encoding techniques (e.g. MJPEG). The decision on the Q metric to be used per slice and/or macro-block can be based on the amount of changes in the given slice / macro-block.

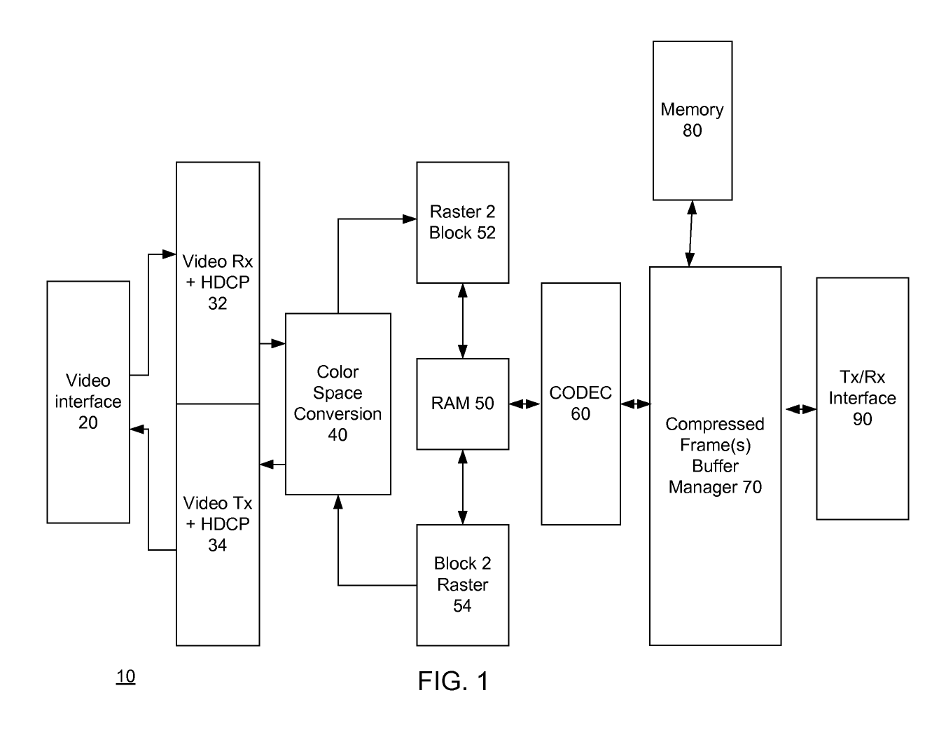

FIG. 1 illustrates a video encoder/decoder chip (integrated circuit) 10 that uses a compressed domain frame buffer implementation. The amount and access speed of the Memory is an order of magnitude smaller relative to state of the art implementation.

The encoder/decoder chip 10 includes a video interface 20, a video receiver and High-bandwidth Digital Content Protection (HDCP) module (“Video Rx +HDPC”) 32, a video transmitter and HDCP module (“Video Tx +HDPC”) 34, a color space conversion module 40, a raster to block converter 52, a block to raster converter 54, a RAM memory 50, a CODEC 60, a memory unit 80, a compressed buffers manager 70 and a transceiver interface (“Tx/Rx interface”) 90.

The transmitting path includes video interface 20, the video transmitter and HDCP module 34, the color space conversion module 40, the raster to block converter 53, the RAM memory 50, the CODEC 60 (which operates as an encoder), the memory unit 80, the compressed buffers manager 70 and the transceiver interface 90.

The receiving path includes the transceiver interface 90, the compressed buffers manager 70, the memory unit 80, the CODEC 60, the block to raster converter 54, the RAM memory 50, the color space conversion module 40, the video transmitter and HDCP module 34 and the video interface 20.

The Video Rx +HDPC 32 is active on the encoder side of the system—CO side of the CODEC. The video arrives in different timing modes and format. The Video Rx +HDPC 32 is configured to meet the relevant resolution (height, width, frames-per-second, pixel-clock, vertical & horizontal blanking and more). In case the video has been encrypted (for content protection, to avoid recording and piracy), the “HDCP” component performs decryption of the incoming encrypted video.

Video Tx +HDPC 34 is active on the decoder side of the system—DEC side of the CODEC. It performs a reverse operation of the Video Rx +HDPC 32—it may encrypt the video (to block piracy on our output), and generate the video timing towards the screen/TV.

The raster to block converter 52 may be active on the encoder side of the system—CO side of the CODEC. Video is sent to screen/TV in a raster fashion (i.e. line by line), but most encoders (frequency domain) operate on 2 dimensional blocks/space. This block manages the collection of multiple lines (into RAM 50), then pulls CODEC blocks (out of RAM 50) towards the encoder.

RAM 50 is used by raster to block converter 52 and block to raster converter 54 and temporary and fast storage.

Block to raster converter 54 may be active on the decoder side of the system—DEC side of the CODEC). Video is sent to screen/TV in a raster fashion (i.e. line by line), but most encoders (frequency domain) operate on 2 dimensional blocks/space. This block manages the collection of multiple CODEC blocks (into RAM 50), then pulls lines (out of RAM 50) towards the screen/TV.

The compressed frame(s) buffer manager 70 may include a skip circuit, one or more encoders, a control module, a hash circuit and the like. It can perform skip operations, CODEC control operations (CODEC selection, multiple quality selection) and the like.

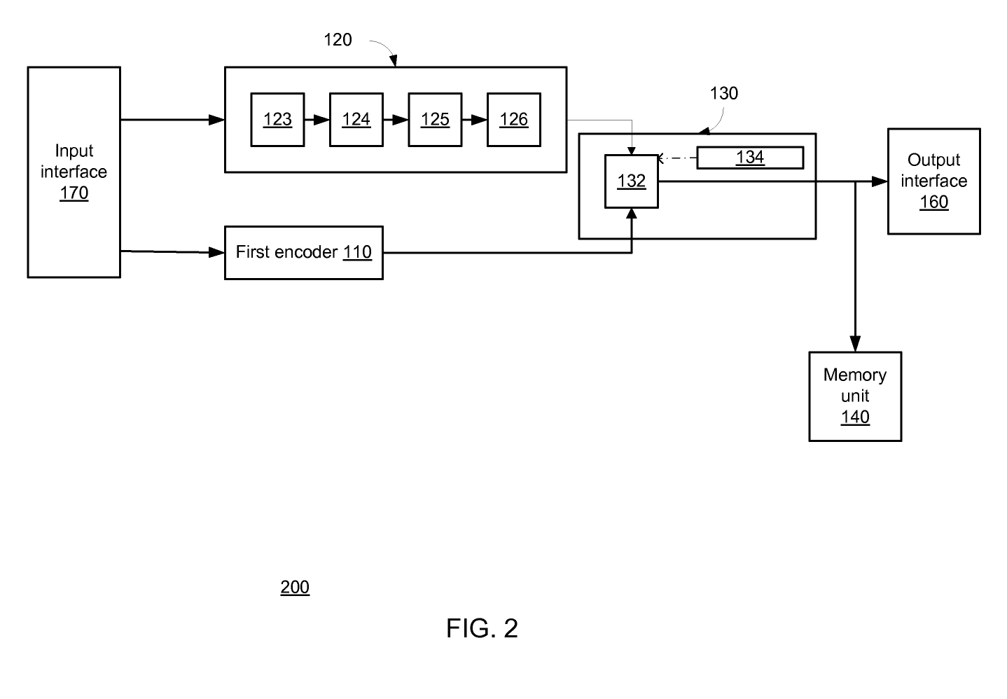

FIG. 2-7 illustrate various devices according to various embodiments of the invention. These devices can perform one more operations (such as encoding) on frame elements (such as macro-blocks). Some of these devices can perform one or more operations (such as determine to skip a transmission) on sets of frame elements (such as slices). Some of the device can perform operations on the entire frames (such as determining to transmit a frame during more than a single frame transmission period).

It is noted that various comparisons can be made between corresponding frame elements of different frames—these frame elements are corresponding to each other as they belong to the same location in their respective frames.

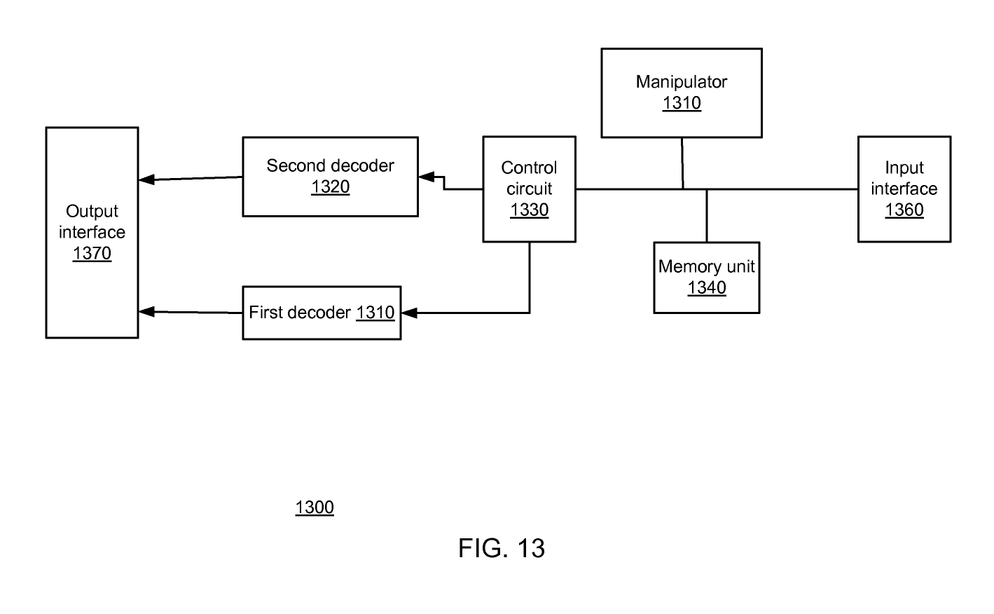

It is noted that the information that is encoded and then transmitted from each of the following devices is received by another device that includes one or more decoders that attempt to reconstruct the input frames—by encoding and other operations. Such a decoding device can retrieve encoding information that is indicative of how frame elements were encoded (encoding parameters may relate to a quality level or other parameters, and in the case that there are more than a single encoder and one of the encoder is selected—the encoding information indicates which encoder was selected). Additionally or alternatively, the decoding device may receive skip information indicative of frame portions (or sets of encoded frame elements) that were not transmitted due to their resemblance (usually identical) to previously transmitted frame portions and then reproduce current frame portions based on previously transmitted frame portions. Yet according to another embodiment of the invention the decoding system can receive difference information that is indicative of a difference between frames (or frame portions) and reconstruct the frames by using a summing circuit. For simplicity of explanation only one example of such decoding device is illustrated—device 1300 of FIG. 13.

FIG. 2 illustrates a device 200, according to an embodiment of the invention.

The device 200 is illustrated as including a first encoder 110, a second encoder 120, a control circuit 130, a memory unit 140, an input interface 170 and an output interface 160.

Each one of the first encoder 110 and the second encoder 120 is connected to the input interface 170 and the control circuit 130. The control circuit 130 is connected to the memory unit 140 and to the output interface 160. An output of the output interface 160 can be connected to a wireless transmitted such as ultra wide band (WUB) transmitter, to a wired transmitter or can include such a transmitter.

The input interface 170 can be a source of input frames or can receive input frames from a media source. Each input frame may include input frame elements (such as macro-blocks or access units) and these input frame elements can be arranged in sets—such as an input slice that includes multiple input frame elements.

The input interface 170 provides input frame elements to the first encoder 110 and to the second encoder 120.

The first encoder 110 is arranged to apply a first type encoding process on an input frame element to provide a first type encoded frame element. The first encoder 110 can be a part of a first CODEC.

The second encoder 120 is arranged to apply a second type encoding process on the input frame element to provide a second type encoded frame element. The type encoding process may differ from the second type encoding process by a degree of expected loss of data. For example, the first type encoding can be a lossless type of encoding while the second type encoding can be a lossy type encoding. Yet for another example—both types of encoding can be lossy type of encoding while one type of encoding is more aggressive than the other—it may be expected to provide more compressed results even at an expense of quality.

The second encoder 120 can be a part of a second CODEC.

The second encoder 120 can include, for example, color format converter 113, a DCT transformer 114, a quantizing module 115 and a Huffman encoder 116. Other modules can be provided—dependent upon the encoding scheme. A frequency domain representation of an input frame can be provided by the DCT transformer 114 or the quantizing module 115.

According to an embodiment of the invention each encoder of the first encoder 110 and second encoder 120 may operate at multiple quality levels—and the device 100 can be arranged to select for each encoder in which quality level to operate.

The control circuit 130 may be arranged to select a selected frame element out of the first and second type encoded frame elements. The selected frame element may be outputted from the output interface 160. The control circuit is illustrated as including a switch 132 and a controller 134 that controls the switch 132.

The memory unit 140 is arranged to store information about the selected frame element. It may store the information about the selected frame element without storing the input frame. The selected frame element is an encoded (compressed) representation of the input frame element—thus the mentioned above storing scheme saves memory space.

According to an embodiment of the invention the first type encoding process is a lossless type encoding process and wherein the second type encoding process is a lossy type encoding process.

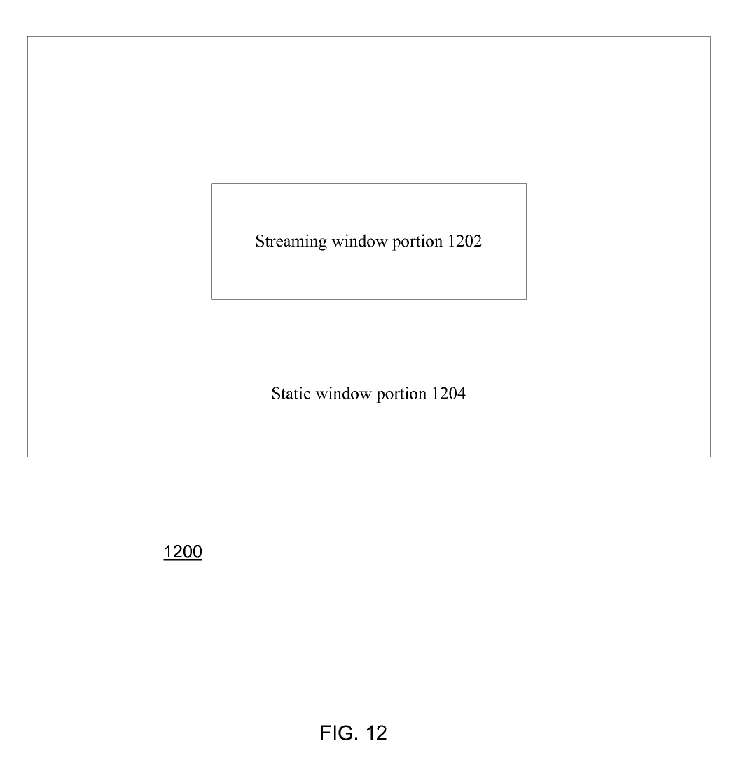

According to an embodiment of the invention, the selection between lossy and lossless encoding depends upon the amount of temporal differences associated with a location of selected frame element in the input frame. For example, lossless encoding may be applied on input frame elements that belong to locations of the input frame that may associated with static content. For example, referring to FIG. 12, if a frame 1200 includes a streaming window portion 1202 in which a media stream is displayed and the streaming window is surrounded by a relatively static portion 1204 than the control circuit 140 can select (i) first type encoded frame elements that belong to the relatively static portion and can select (ii) second type encoded frame elements that belong to the streaming media portion. This separation may be beneficial when the video is eventually (after being transmitted over a medium and decoded) displayed on a computer screen or any other screen or display connected to a computer as users of computers are expected to be sensitive to degradations in static features of the screen—especially those feature which are expected to remain the same during long periods (few seconds and more).

It is noted that the selection may change over time due to overall bandwidth constraints. For example, when there is less bandwidth lossy encoding can replace lossless encoding.

According to an embodiment of the invention a quality level of one of the encoders can change. The change may include prioritizing locations that are more static. The prioritization can result in allocating more bandwidth (more bit rate) to encoded frame elements of more static locations, trying to limit a reduction of quality of such encoded frame elements in relation to frame elements of more dynamic locations of the frame, and the like.

The control circuit 140 may be arranged to change encoding parameters for different input frame elements that belong to different locations of the input frame in response to changes in an overall bit rate allocated to the input frame and in response to the amount of temporal changes associated with the different locations.

The control circuit 140 may be arranged to change the encoding parameters while prioritizing input frame elements that belong to locations of the input frame that are more static than other locations of the frames.

According to an embodiment of the invention the control circuit 140 can compare the sizes of the first type encoded frame element and the second type encoded frame element and can, for example, transmit the smaller encoded frame. If, for example, the first type encoding process is a lossless type encoding process and the second type encoding process is a lossy type encoding process then the control circuit 140 can select the first type encoded frame element if it is smaller than the second type encoded frame element or if the difference between these frame element is small enough (smaller than a size threshold that can be set to about 10% size difference).

According to an embodiment of the invention the first type of encoding is Portable Network Graphics (PNG) and the second type of encoding is JPEG or motion JPEG.

The color format converter 113 can be arranged to encoder is arranged to perform a downsizing format conversion of the input frame element to provide a format converted frame element. Thus, the downsizing format conversion reduced the size of the input frame element. Thus, fewer bits can be allocated to one or more pixel components. A non-limiting example of a downsizing format conversion may include converting a 4:4:4 format to a 4:2:2 format.

Device 200 can determine to skip the downsizing format conversion if it introduces intolerable errors. An intolerable error can be defined as an error that exceeds a predefined error threshold. The error can be calculated as a difference between pixels of the format converted frame element and pixels of the input frame elements.

The error can be calculated as a difference between attributes of pixels of the format converted frame element and attribute of pixels of the input frame elements. A non-limiting example of an attribute of a pixel includes a square of the value of the pixel.

Device 200 can determine whether to skip the downsizing format conversion based on a relationship between (a) the input frame element and (b) a reconstructed frame element. The reconstructed frame element can be generated by applying an upsizing format conversion on the format converted frame element, wherein the reconstructed frame element has a same format as the input frame element.

According to an embodiment of the invention the control circuit 140 may be arranged to select, for each of the first encoder and second encoder, a selected quality level of encoding out of multiple allowable quality levels. The selection an be responsive to various parameters such as an allocated bit rate (bandwidth), a size reduction obtained when operating at the different quality levels and the like.

Device 200 may be arranged to store and transmit encoding information that is indicative of how frame elements were encoded (encoding parameters may relate to a quality level or other parameters, and which encoder out of first encoder 110 and second encoder 120 was selected—whether the first type encoded frame element or the second type encoded frame element was elected.

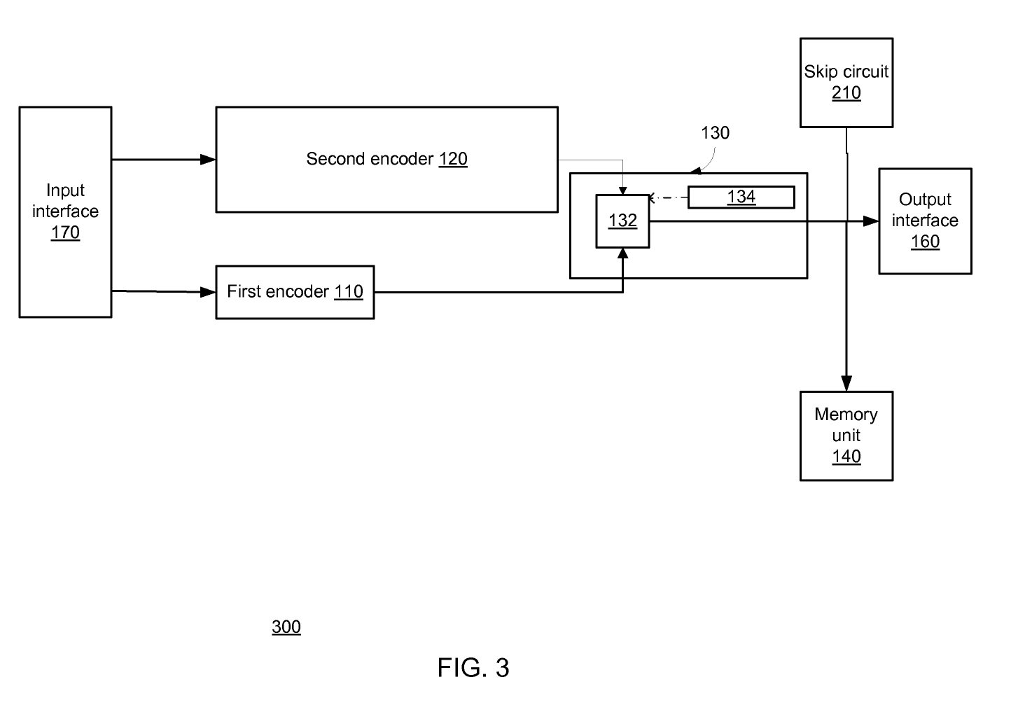

FIG. 3 illustrates device 300, according to an embodiment of the invention.

The device 300 of FIG. 3 differs from the device 200 of FIG. 2 by including a skip circuit 210. The skip circuit 210 is connected to the memory unit 140, to the control circuit 130 and to the output interface 160.

The skip circuit 210 can be arranged to determine whether to transmit a current set of selected frame elements that belong to a current input frame or to skip their transmission and rather send skip information. The skip information may indicate that the current set equals (or at least substantially equals) a previous set of selected frame elements that belong to previous frames. This further reduces the amount of traffic.

The skip circuit 210 may be arranged to perform a comparison between (i) information about a current set and information about a previous set and (ii) information about a previous set. The previous set and the current set belong to the same location in their respective frames.

The skip circuit 210 can determine, based on a result of the comparison, whether the output interface 160 shall output the current set or be prevented from outputting the current set and instead output skip information.

It is noted that the skip information can be transmitted per each skipped set or per multiple skipped sets.

The information about each set (current set and previous set) can be the set itself, can be a hash value representative of the set, can be partially decoded representation of the set, can be a frequency domain representation of the set, can be a fully decoder representation of the set and the like.

According to an embodiment of the invention the device can also elect to transmit difference information instead of the current set. Thus, for example, skip circuit 210 can compare between the current sent and a previous set (for example—the last set that was transmitted before the current set) to generate difference information. The difference information can be transmitted if, for example, it is smaller (by at least a certain amount) from the current set itself.

Device 300 may be arranged to store and transmit encoding information that is indicative of how frame elements were encoded (encoding parameters may relate to a quality level or other parameters, and which encoder out of first encoder 110 and second encoder 120 was selected—whether the first type encoded frame element or the second type encoded frame element was elected.

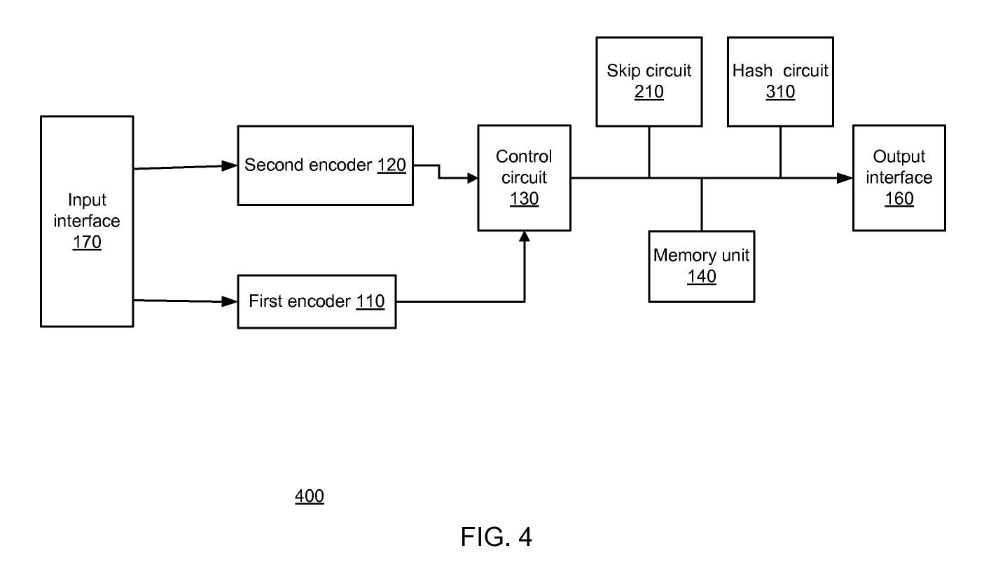

FIG. 4 illustrates device 400, according to an embodiment of the invention.

Device 400 of FIG. 4 differs from the device 300 of FIG. 3 by including a hash circuit 310. The hash circuit 310 may be connected to the memory unit 140, to control circuit 130 and to the skip circuit 210.

The hash circuit 310 can calculate a hash value per each selected frame element. The hash value can be sent to the memory unit 140 and to the skip circuit 310. The memory unit 140 can store the hash value of a selected frame element and not store the selected frame element or the input frame element. This result in further saving of memory space.

The skip information can compare a hash value of (i) at least one hash value of the at least one selected frame element of the current set and (ii) at least one hash value of the at least one previously selected frame element, and based on this comparison may select whether to transmit of skip a current set.

The current set can be a slice of the input frame. The previous set can be a slice of a previous frame that is located at a same location. The skip circuit 210 can be arranged to determine whether the output interface 160 will output the slice of the input frame or to transmit skip information indicative of a determination not to output the slice of the input frame.

Yet according to another embodiment of the invention the skip circuit 210 can be arranged to detect that the input frame and at least one previous frame form a sequence of frames that are equal to each other; and to allocate multiple frame transmission periods to a transmission of one frame of the sequence of frames.

Yet according to a further embodiment of the invention the skip circuit 210 can be arranged to detect that the input frame and at least one previous frame form a sequence of frames that are equal to each other; to analyze one frame of the sequence of frames to provide an analysis result and to determining at least one encoding parameter based on the analysis result.

Device 400 may be arranged to store and transmit encoding information that is indicative of how frame elements were encoded (encoding parameters may relate to a quality level or other parameters, and which encoder out of first encoder 110 and second encoder 120 was selected—whether the first type encoded frame element or the second type encoded frame element was elected.

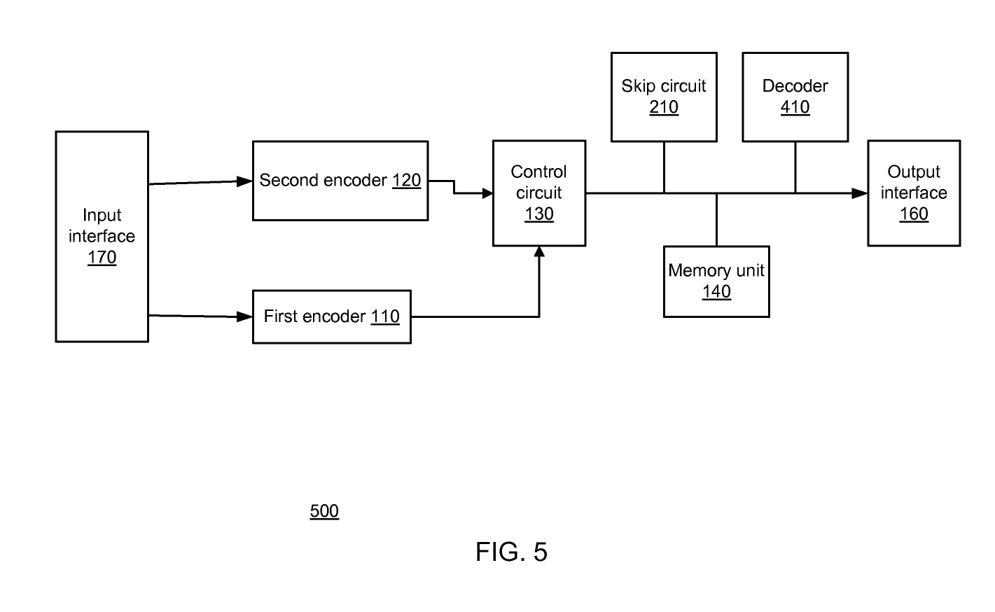

FIG. 5 illustrates device 500, according to an embodiment of the invention.

Device 500 of FIG. 5 differs from device 300 of FIG. 3 by including a decoder 410 that is arranged to: (a) partially decode the current set to provide the information about the current set; and (b) partially decode the previous set to provide the information about the previous set.

The partially decoded current set and the partially decoded previous set are sent to the skip circuit that can determine (based on the resemblance between them) whether to transmit the current set or to skip it.

The partially decoding can provide a frequency domain representation of the current set and a frequency domain representation of the previous set.

According to yet another embodiment of the invention the decoder 410 is arranged to fully decode fully decode the current set to provide the information about the current set; and to fully decode the previous set to provide the information about the previous set. Thus, a pixel domain representation of the current set and the previous set can be sent from the decoder 410 to the skip circuit 210.

Device 500 may be arranged to store and transmit encoding information that is indicative of how frame elements were encoded (encoding parameters may relate to a quality level or other parameters, and which encoder out of first encoder 110 and second encoder 120 was selected—whether the first type encoded frame element or the second type encoded frame element was elected.

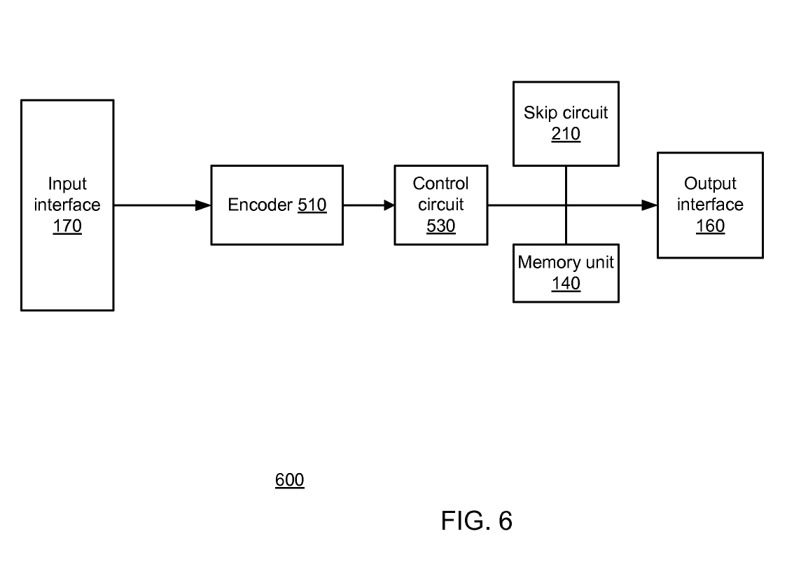

FIG. 6 illustrates a device 600 according to an embodiment of the invention.

The device 600 includes an encoder 510, a control circuit 530, a memory unit 140, a skip circuit 540 and an input interface 170 and an output interface 160.

The encoder 510 can be connected to the input interface 170 and the control circuit 530. The control circuit 530 is connected to the memory unit 140, to the skip circuit 540 and to the output interface 160. An output of the output interface 160 can be connected to a wireless transmitted such as ultra wide band (WUB) transmitter, to a wired transmitter or can include such a transmitter.

The encoder 510 is arranged to encode an input frame portion to provide a currently encoded frame portion, the input frame portion belongs to an input frame.

The memory unit 140 may be arranged to store a previously encoded frame portion without storing a previous frame. The previously encoded frame portion is generated from a portion of the previous frame. The previously encoded frame portion is located at a certain location of the previous frame. The currently encoded frame portion is located at the certain location of the input frame.

The skip circuit 540 can be arranged to: perform a comparison between information about the currently encoded frame portion and information about the previously encoded frame portion; and determine, based on a result of the comparison, whether the device shall output the currently encoded frame portion or information indicative of a determination to skip a transmission of the currently encoded frame portion.

According to another embodiment of the invention the skip circuit 540 may be arranged to perform a comparison between (i) at least one hash value of the currently encoded frame portion and (ii) at least one hash value of the at least one previously selected frame element.

The memory unit 140 may be arranged to store hash values of previously encoded frame portions and is prevented from storing previously received input frame portions that were encoded to provide the previously encoded frame portion.

Device 600 may be arranged to store and transmit encoding information that is indicative of how frame elements were encoded—a quality level or other parameters.

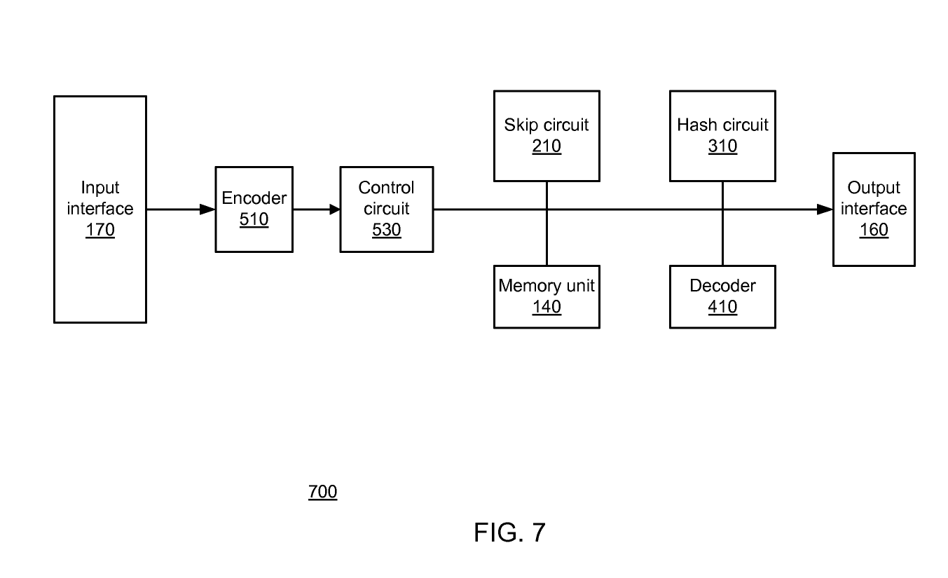

FIG. 7 illustrates a device 700 according to an embodiment of the invention.

Device 700 of FIG. 7 differs from device 500 of FIG. 5 by including a decoder 410 and a hash circuit 310. It is noted that the encoding circuit can include only one of these circuits (410 or 310).

The hash circuit 310 may be connected to the memory unit 140, to control circuit 530 and to the skip circuit 210.

The hash circuit 310 can calculate a hash value per each selected frame element. The hash value can be sent to the memory unit 140 and to the skip circuit 310. The memory unit 140 can store the hash value of a selected frame element and not store the selected frame element or the input frame element. This result in further saving of memory space.

The skip information can compare a hash value of (i) at least one hash value of the at least one selected frame element of the current set and (ii) at least one hash value of the at least one previously selected frame element, and based on this comparison may select whether to transmit of skip a current set.

The current set can be a slice of the input frame. The previous set can be a slice of a previous frame that is located at a same location. The skip circuit 210 can be arranged to determine whether the output interface 160 will output the slice of the input frame or to transmit skip information indicative of a determination not to output the slice of the input frame.

Yet according to another embodiment of the invention the skip circuit 210 can be arranged to detect that the input frame and at least one previous frame form a sequence of frames that are equal to each other; and to allocate multiple frame transmission periods to a transmission of one frame of the sequence of frames.

Yet according to a further embodiment of the invention the skip circuit 210 can be arranged to detect that the input frame and at least one previous frame form a sequence of frames that are equal to each other; to analyze one frame of the sequence of frames to provide an analysis result and to determining at least one encoding parameter based on the analysis result.

The decoder 410 can be arranged to: (a) partially decode the current set to provide the information about the current set; and (b) partially decode the previous set to provide the information about the previous set.

The partially decoded current sent and the partially decoded previous set are sent to the skip circuit that can determine (based on the resemblance between them) whether to transmit the current set or to skip it.

The partially decoding can provide a frequency domain representation of the current set and a frequency domain representation of the previous set.

According to yet another embodiment of the invention the decoder 410 is arranged to fully decode fully decode the current set to provide the information about the current set; and to fully decode the previous set to provide the information about the previous set. Thus, a pixel domain representation of the current set and the previous set can be sent from the decoder 410 to the skip circuit 210.

Device 600 may be arranged to store and transmit encoding information that is indicative of how frame elements were encoded—a quality level or other parameters.

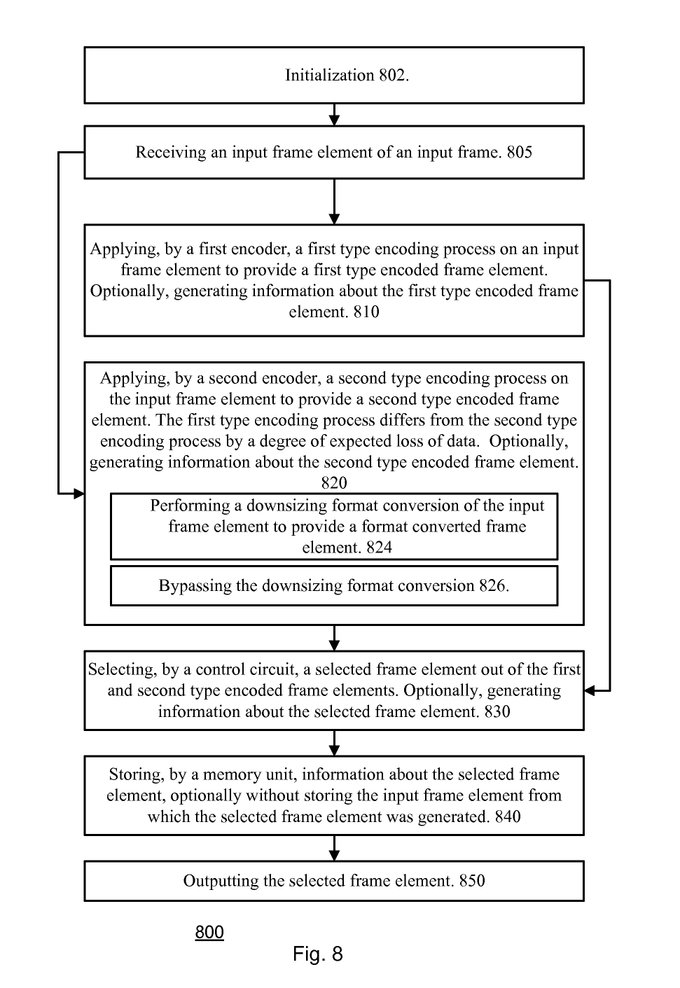

FIG. 8 illustrates a method 800 for encoding, according to an embodiment of the invention.

Method 800 may start by an initialization stage 802. The initialization stage 802 may include determining a configuration of a device. For example, stage 802 may include (a) changing encoding parameters for different input frame elements that belong to different locations of the input frame in response to changes in an overall bit rate allocated to the input frame and in response to the amount of temporal changes associated with the different locations. Stage 820 may, additionally or alternatively include (ii) changing the encoding parameters while prioritizing input frame elements that belong to locations of the input frame that are more static than other locations of the frames.

Yet for another example, stage 802 may include selecting, for each of the first encoder and second encoder, a selected quality level of encoding out of multiple allowable quality levels.

Stage 802 may be followed by stage 805 of receiving an input frame element of an input frame. This input frame may also be referred to a current input frame as it is being currently received and processed. The input frame elements may be arranged in sets. For example, the input frame element can be long to a current set that include at least one input frame element.

Stage 805 is followed by stages 810 and 820.

Stage 810 includes applying, by a first encoder, a first type encoding process on an input frame element to provide a first type encoded frame element. The input frame element belongs to an input frame. Stage 810 may include generating information about the first type encoded frame element. This information can be the first type encoded frame element itself, a result of a mathematical function applied on the first type encoded frame element, a hash value of the first type encoded frame element, a partially encoded first type encoded frame element and the like.

Stage 820 includes applying, by a second encoder, a second type encoding process on the input frame element to provide a second type encoded frame element; wherein the first type encoding process differs from the second type encoding process by a degree of expected loss of data. Stage 820 may include generating information about the second type encoded frame element. This information can be the second type encoded frame element itself, a result of a mathematical function applied on the second type encoded frame element, a hash value of the second type encoded frame element, a partially encoded second type encoded frame element and the like.

Stages 810 and 820 can be followed by stage 830 of selecting, by a control circuit, a selected frame element out of the first and second type encoded frame elements.

The input frame element may be located at a certain location of the input frame and stage 830 may include selecting the selected frame element based upon an amount of temporal changes associated with the certain location. Stage 830 may include selecting the first type encoded frame element if the certain location is associated with static content.

Stage 830 may include generating information about the selected frame element. This information can be the selected frame element itself, a result of a mathematical function applied on the selected frame element, a hash value of the selected frame element, a partially encoded selected frame element and the like. This gathering of information can be provided in addition to or instead of gathering information during stage 810 and 820.

Stage 830 may be followed by stage 840 of storing, by a memory unit, information about the selected frame element. Stage 840 may include storing the information about the selected frame element without storing the input frame element from which the selected frame element was generated.

Stage 840 may be followed by stage 850 of outputting the selected frame element.

Stage 850 may be followed by stage 805 during which a new input frame element is received.

Stage 810 may include applying a lossless type encoding process and stage 820 may includes applying a lossy type encoding process. Under this assumptions stage 830 may include selecting the first type encoded frame element if the first type encoded frame element is smaller than the second type encoded frame element.

Additionally or alternatively, stage 830 may include selecting the first type encoded frame element if a size difference between the first type encoded frame element and the second type encoded frame element is below a size threshold.

Stage 820 may include stage 824 of performing a downsizing format conversion of the input frame element to provide a format converted frame element. According to an embodiment of the invention this downsizing format conversion can be bypassed—by selecting the input frame element. The bypassing (stage 826) may include determining to bypass (or cancel) the downsizing format conversion in response to a relationship between (a) the input frame element and (b) a reconstructed frame element, wherein the reconstructed frame element is generated by applying an upsizing format conversion on the format converted frame element, wherein the reconstructed frame element has a same format as the input frame element.

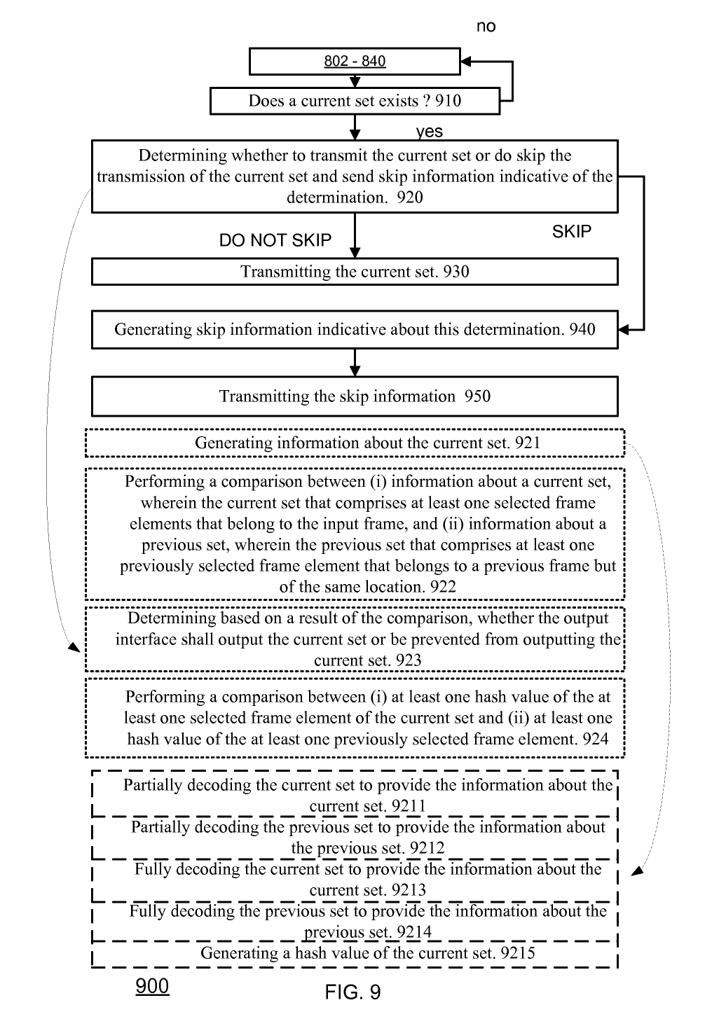

FIG. 9 illustrates a method 900 for encoding, according to an embodiment of the invention.

Method 900 differs from method 800 by providing an option to skip the transmission of a current set of input frame elements.

Method 900 includes repeating stages 802-840 (or at least stage 805-840) until a current set of input frame element is received and selected frame elements of the current set are selected and stored (except maybe that last selected frame element) in the memory unit. Once the current set is provided method 900 proceeds to determine whether to transmit the current set or, if the current set is equal or at least substantially equal to the last (previous) set of previously selected frame elements—and if so the method 900 can determine not to transmit the current set but to generate skip information indicative of the determination.

The repetition of stages 802-840 is illustrated by query stage 910 of “does a current set exists?”

If the answer is positive (a current set exists) then stage 910 is followed by stage 920.

If the answer is negative (no current set exists yet)—there are not enough selected frame elements to form a current set then stage 910 is followed by stage 802 or 805. FIG. 9 illustrates stage 910 as followed by stage 805.

Stage 920 may include determining whether to transmit the current set or do skip the transmission of the current set and send skip information indicative of the determination. Stage 920 can be executed by a skip circuit.

If, during stage 920, it is determined to transmit the current set then stage 920 is followed by stage 930 of transmitting the current set. The transmission can be executed one selected frame element of the current set at a time—but this is not necessarily so. Stage 930 may be followed by stage 802 or 805.

If, during stage 920, it is determined not to transmit the current set (skip) then stage 920 is followed by stage 940 of generating skip information indicative about this determination. The skip information can be transmitted (stage 950) per determination (per set) but can also be delayed—especially if more than a pair of sets are equal to each other.

Stage 920 can include at least one of the following stages:

Stage 921 of generating information about the current set. This information can be the current set itself, a result of a mathematical function applied on the current set, a hash value of the current set, a partially encoded current set and the like. The information about the current set can be based on (or generated in response to) information gathered (during stages 802-840) on the selected frame elements (for example- such information can be gathered during either one of stages 810, 820 or 830. Alternatively, this information can be acquired regardless of information gathered (if any) during stages 810, 820 or 830.

Stage 922 of performing a comparison between (i) information about a current set, wherein the current set that comprises at least one selected frame elements that belong to the input frame, and (ii) information about a previous set, wherein the previous set that comprises at least one previously selected frame element that belongs to a previous frame but of the same location.

Stage 923 of determining based on a result of the comparison, whether the output interface shall output the current set or be prevented from outputting the current set.

Stage 924 of performing a comparison between (i) at least one hash value of the at least one selected frame element of the current set and (ii) at least one hash value of the at least one previously selected frame element.

According to various embodiments of the invention stage 921 can include at least one of the following stages:

Stage 9211 of partially decoding the current set to provide the information about the current set. The partially decoding can provide a frequency domain representation of the current set.

Stage 9212 of partially decoding the previous set to provide the information about the previous set. The partially decoding can provide a frequency domain representation of the previous set.

Stage 9213 of fully decoding the current set to provide the information about the current set.

Stage 9214 off fully decoding the previous set to provide the information about the previous set.

Stage 9215 of generating a hash value of the current set. This has value can be stored in the memory unit and once a newer set is processed (and the current set becomes a previous set) this has value can be provided as a hash value of a previous set. The hash value can be calculated per each selected frame element and these hash values can be further processed to provide the hash value of the current set. Additionally or alternatively, the hash value can be calculated once the entire current set is received and selected frame elements of the entire current set are provided.

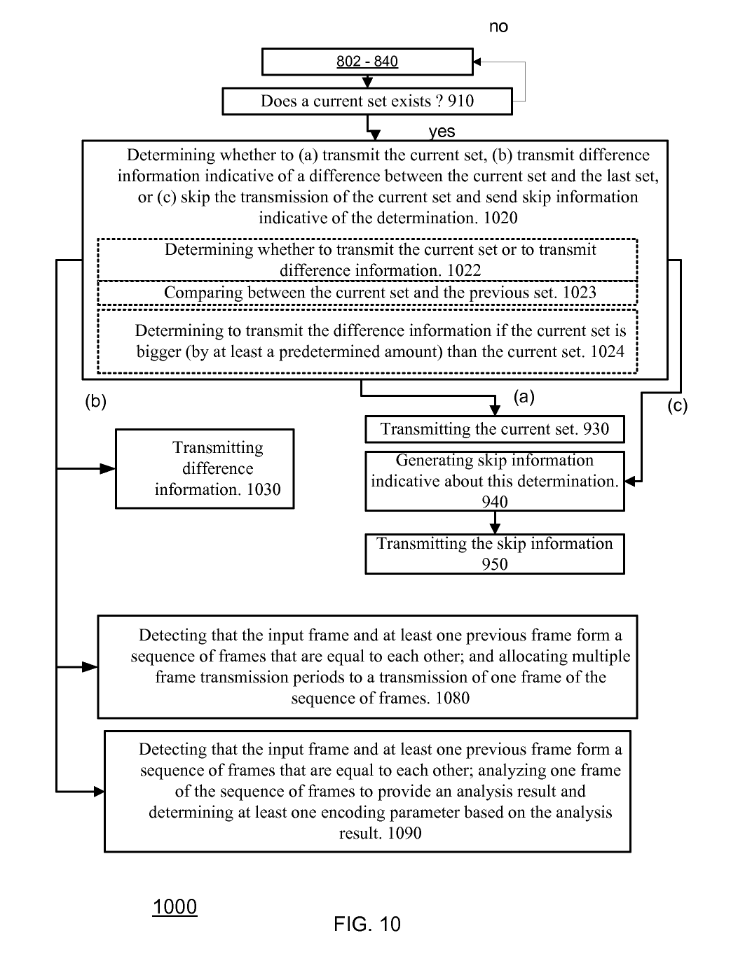

FIG. 10 illustrates a method 1000 for encoding, according to an embodiment of the invention.

Method 1000 differs from method 900 by allowing a transmission of difference information instead of transmitting the current set. It is noted that the difference information can be generated per selected frame element and the determination can be made on a selected frame element basis. It is further noted that method 800 can include a stage of generating difference information (between a selected frame element and a previous frame element that belongs to the same location but of a different frame) and determining whether to transmit the difference information.

Method 1000 includes repeating stages 802-840 (or at least stage 805-840) until a current set of input frame element is received and selected frame elements of the current set are selected and stored (except maybe that last selected frame element) in the memory unit.

The repetition of stages 802-840 is illustrated by query stage 910 of “does a current set exists?”

If the answer is positive (a current set exists) then stage 910 is followed by stage 1020. Else- stage 910 may be followed by stage 802 or 805.

Stage 1020 includes determining whether to (a) transmit the current set, (b) transmit difference information indicative of a difference between the current set and the last set, or (c) skip the transmission of the current set and send skip information indicative of the determination.

If determining to transmit the current set then stage 1020 is followed by stage 930 of transmitting the current set.

If determining to transmit difference information then stage 1020 is followed by stage 1030 of transmitting difference information.

If determining to skip the current set then stage 1020 is followed by stage 940 of generating skip information indicative about this determination. The skip information can be transmitted (stage 950) per determination (per set) but can also be delayed—especially if more than a pair of sets are equal to each other.

Stage 1020 can include any of the stages included in stage 902 and the stages included in stage 920. In addition, stage 1020 includes stage 1022 of determining whether to transmit the current set of to transmit difference information.

The determining 1022 can include (a) comparing (1023) between the current set and the previous set and (b) determining (1024) to transmit the difference information if the current set is bigger (by at least a predetermined amount) than the current set. It is noted that the comparison can be made between information about the current set and information about the difference information.

According to yet another embodiment of the invention method 1000 (or any one of the previous methods) can include a stage 1080 of detecting that the input frame and at least one previous frame form a sequence of frames that are equal to each other; and allocating multiple frame transmission periods to a transmission of one frame of the sequence of frames.

According to yet another embodiment of the invention method 1000 (or any one of the previous methods) can include a stage 1090 of detecting that the input frame and at least one previous frame form a sequence of frames that are equal to each other; analyzing one frame of the sequence of frames to provide an analysis result and determining at least one encoding parameter based on the analysis result. The determining can be a part of initialization stage 802.

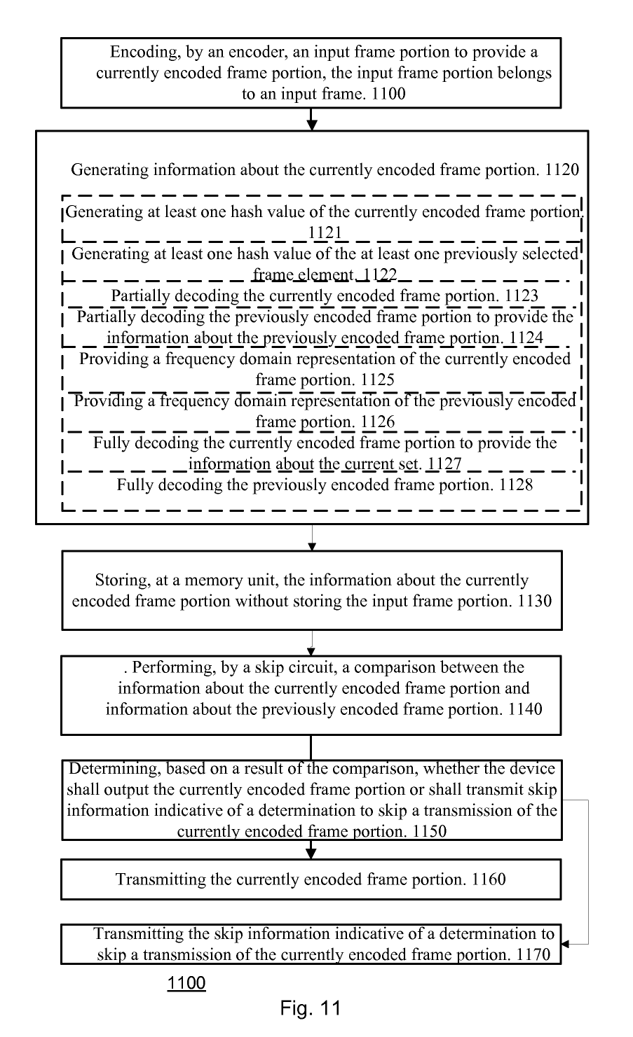

FIG. 11 illustrates a method 1100 for encoding, according to an embodiment of the invention.

Method 1100 can start by stage 1110 of encoding, by an encoder, an input frame portion to provide a currently encoded frame portion; the input frame portion belongs to an input frame.

Stage 1110 may be followed by stage 1120 of generating information about the currently encoded frame portion. If the information about the currently encoded frame is the currently encoded frame itself then stage 1120 can be ignored.

Stage 1130 includes storing, by a memory unit, the information about the currently encoded frame portion without storing the input frame portion.

Stage 1130 may be followed by stage 1140 of performing, by a skip circuit, a comparison between the information about the currently encoded frame portion and the information about the previously encoded frame portion.

Stage 1140 may be followed by stage 1150 of determining, based on a result of the comparison (of stage 1140), whether the device shall output the currently encoded frame portion (and jump to stage 1160) or shall transmit skip information indicative of a determination to skip a transmission of the currently encoded frame portion (and jump to stage 1170).

Stage 1160 includes transmitting the currently encoded frame portion.

Stage 1170 includes transmitting the skip information indicative of a determination to skip a transmission of the currently encoded frame portion.

Stage 1120 can include at least one of the following: (a) generating (1121) at least one hash value of the currently encoded frame portion; (b) generating (1122) at least one hash value of the at least one previously selected frame element; (c) partially decoding (1123) the currently encoded frame portion; (d) partially decoding (1124) the previously encoded frame portion to provide the information about the previously encoded frame portion; (e) providing (1125) a frequency domain representation of the currently encoded frame portion; (f) providing (1126)) a frequency domain representation of the previously encoded frame portion; (g) fully decoding (1127) the currently encoded frame portion to provide the information about the current set; (h) fully decoding (1128) the previously encoded frame portion.

According to an embodiment of the invention method 1100 can also include determining whether the output interface should output the currently encoded frame portion or difference information indicative of a difference between the currently encoded frame portion and the previously encoded frame portion.

It is noted that any encoder system can include more than two encoders and that each encoder may apply a type of encoding that differs from all other types of encoding applied by the other encoder.

It is further noted that each device can belong a device that further includes a decoding device that may attempt to reverse the encoding. A system may be provided and may include multiple units, each units may include a device and additionally or alternatively a decoding device, wherein a decoding device attempts to reverse the encoding performed by a device.

According to an embodiment of the invention the type of encoding selected (the encoder selected) and optionally the quality level can be transmitted to a decoding device than attempts to reconstruct the input frames based on encoded frames it receives.

FIG. 13 illustrates a decoding device 1300 according to an embodiment of the invention. The decoding device 1300 can attempt to reconstruct input frames.

The device 1300 is illustrated as including a first decoder 1310, a second decoder 1320, a control circuit 1330, a memory unit 1340, an input interface 1370, a manipulator 1380 and an output interface 1360.

Each one of the first decoder 1310 and the second decoder 1320 is connected to the output interface 1370 and to the control circuit 1330. The control circuit 1330 is connected to the memory unit 1340, to the manipulator 1380 and to the input interface 1360.

An input of the input interface 1360 can be connected to a wireless receiver such as ultra wide band (WUB) receiver, to a wired receiver or can include such a receiver.

The output interface 1370 can provide the output frames or store them.

The output interface 1370 can receive an output frame elements from the first decoder 1310 or from the second decoder 1320.

The first decoder 1310 is arranged to apply a first type decoding process on a received frame element to provide a first type decoded frame element.

The first decoder 1320 is arranged to apply a second type decoding process on a received frame element to provide a second type decoded frame element.

The control circuit 1330 can receive (or extracts) encoding information from the input interface 1360 can, according to the encoding information, elect which decoder to apply. The control circuit 1330 can also determine how to activate the selected decoder.

The manipulator 1310 can receive (from the input interface 1360 or from the control circuit) skip information and additionally or alternatively difference indication and reconstruct (in the compressed domain) frame elements. These reconstructed frame elements are fed to a selected decoder.

This decoding system 1300 can reconstruct input frames provided by any of the mentioned above systems of FIGS. 2-7. When reconstructing input frame elements from a single encoder system—there is no need to select a decoder. If there are more than two encoders in the encoding system then the decoding system 1300 may have more than two decoders.

The decoding system 1300 and especially the memory unit 1340 can store compressed (encoded) frame elements and may be prevented from storing the frame elements after the decoding. This may assist in reducing memory size and increasing memory speed.

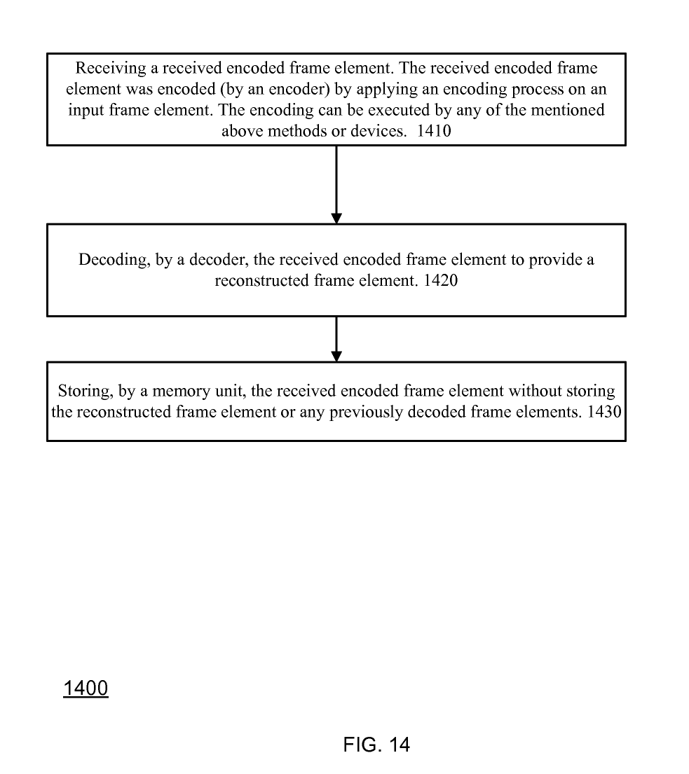

FIG. 14 illustrates method 1400 according to an embodiment of the invention.

Method 1400 starts by stage 1410 of receiving a received encoded frame element. The received encoded frame element was encoded (by an encoder) by applying an encoding process on an input frame element. The encoding can be executed by any of the mentioned above methods or devices.

Stage 1410 is followed by stage 1420 decoding, by a decoder, the received encoded frame element to provide a reconstructed frame element.

Stage 1420 is followed by stage 1430 of storing, by a memory unit, the received encoded frame element without storing the reconstructed frame element or any previously decoded frame elements. Thus, the memory unit may store only received encoded frame elements and does not store decoded frame elements. The decoding process may require previously received frame elements and these previously received frame elements may be provided by the memory unit.

Method 1400 may attempt to reverse any encoding process executed by any of the mentioned above methods or devices. Thus, the decoding may be responsive to skip information, encoding information and the like. For example, if skip information is relieved the decoder can decode a set of received encoded frame elements and another circuit can replicate them. Alternatively, the decoding can repeat itself until reaching the number of equal (or substantially equal) sets are provided. Yet for another example, the decoding process can be responsive to which encoding (out of multiple encoding schemes) was applied (for example—lossy or lossless) and which encoding parameters (for example—quality of a lossy encoding process) were applied—in order to apply corresponding decoding types and parameters.

Any of the mentioned above methods can be executed by a computer that executes instructions stored in a non-transitory computer readable medium such as disk, diskette, tape, integrated circuit, storage device and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A device, comprising:
a first encoder arranged to apply a first type encoding process on an input frame element to provide a first type encoded frame element; the input frame elements belong to an input frame;
a second encoder arranged to apply a second type encoding process on the input frame element to provide a second type encoded frame element; wherein the first type encoding process differs from the second type encoding process by a degree of expected loss of data;
a control circuit arranged to select a selected frame element out of the first and second type encoded frame elements;
a memory unit arranged to store information about the selected frame element; and
an output interface arranged to output the selected frame element.

2. The device according to claim 1, wherein the memory unit is arranged to store the information about the selected frame element while not storing the input frame.

3. The device according to claim 1, wherein the first type encoding process is a lossless type encoding process and wherein the second type encoding process is a lossy type encoding process.

4. The device according to claim 3, wherein the input frame element is located at a certain location of the input frame; wherein the control circuit is arranged to select the selected frame element based upon an amount of temporal changes associated with the certain location.

5. The device according to claim 4, wherein the control circuit is arranged to select the first type encoded frame element if the certain location is associated with static content.

6. The device according to claim 3, wherein the control circuit is arranged to change encoding parameters for different input frame elements that belong to different locations of the input frame in response to changes in an overall bit rate allocated to the input frame and in response to the amount of temporal changes associated with the different locations.

7. The device according to claim 6, wherein the control circuit is arranged to change the encoding parameters while prioritizing input frame elements that belong to locations of the input frame that are more static than other locations of the frames.

8. The device according to claim 3, wherein the control circuit is arranged to select the first type encoded frame element if the first type encoded frame element is smaller than the second type encoded frame element.

9. The device according to claim 3, wherein the control circuit is arranged to select the first type encoded frame element if a size difference between the first type encoded frame element and the second type encoded frame element is below a size threshold.

10. The device according to claim 1, wherein the second encoder is arranged to perform a downsizing format conversion of the input frame element to provide a format converted frame element;
wherein the control circuit is arranged to select the selected frame element based on a relationship between (a) the input frame element and (b) a reconstructed frame element; and
wherein the reconstructed frame element is generated by applying an upsizing format conversion on the format converted frame element, wherein the reconstructed frame element has a same format as the input frame element.

11. The device according to claim 3, wherein the control circuit is arranged to select, for the second encoder, a selected quality level of encoding out of multiple allowable quality levels.

12. The device according to claim 1, further comprising a skip circuit that is arranged to:
perform a comparison between (i) information about a current set, wherein the current set that comprises at least one selected frame elements that belong to the input frame, and (ii) information about a previous set, wherein the previous set that comprises at least one previously selected frame element that belongs to a previous frame but of the same location; and
determine, based on a result of the comparison, whether the output interface shall output the current set or be prevented from outputting the current set.

13. The device according to claim 12, wherein the first type encoding process is a lossless type encoding process and wherein the second type encoding process is a lossy type encoding process.

14. The device according to claim 13, wherein the skip circuit is arranged to perform the comparison between the current set and the previous set.

15. The device according to claim 13, wherein the skip circuit is arranged to perform a comparison between (i) at least one hash value of the at least one selected frame element of the current set and (ii) at least one hash value of the at least one previously selected frame element.

16. The device according to claim 13, wherein the memory unit is arranged to store hash values of frame elements of previous frames and is prevented from storing the frame elements of the previous frames.

17. The device according to claim 13, wherein the current set is a slice of the input frame and wherein the previous set is a slice of a previous frame that is located at a same location; wherein the skip circuit is arranged to determine whether the output interface will output the slice of the input frame or to transmit skip information indicative of a determination not to output the slice of the input frame.

18. The device according to claim 13, wherein the skip circuit is arranged to send to the output interface skip information indicative of a determination not to transmit the current set.

19. The device according to claim 13, comprising an decoder that is arranged to:
partially decode the current set to provide the information about the current set; and
partially decode the previous set to provide the information about the previous set.

20. The device according to claim 19, wherein the decoder is arranged to partially decode the current set to provide a frequency domain representation of the current set.

21. The device according to claim 13, comprising an decoder that is arranged to:
fully decode the current set to provide the information about the current set; and
fully decode the previous set to provide the information about the previous set.

22. The device according to claim 13, further arranged to determine whether the output interface should output the current set or difference information indicative of a difference between the current set and the previous set.

23. The device according to claim 3, comprising a skip circuit that is arranged to detect that the input frame and at least one previous frame form a sequence of frames that are equal to each other; and to allocate multiple frame transmission periods to a transmission of one frame of the sequence of frames.

24. The device according to claim 3, comprising a skip circuit that is arranged to detect that the input frame and at least one previous frame form a sequence of frames that are equal to each other; to analyze one frame of the sequence of frames to provide an analysis result and to determining at least one encoding parameter based on the analysis result.

25. The device according to claim 3, comprising a skip circuit that is arranged to detect that the selected frame element and at least one previous selected frame element of a same location form a sequence of selected frame elements frames that are equal to each other; and to allocate multiple frame element transmission periods to a transmission of one frame element of the sequence of frame elements.

26. The device according to claim 3, comprising a skip circuit that is arranged to detect that the input frame and at least one previous frame form a sequence of frames that are equal to each other; to analyze one frame of the sequence of frames to provide an analysis result and to determining at least one encoding parameter based on the analysis result.

27. The device according to claim 3, comprising a skip circuit that is arranged to detect that the selected frame element and at least one previous selected frame element of a same location form a sequence of selected frame elements frames that are equal to each other; and to analyze one selected frame element of the sequence of selected frame elements to provide an analysis result and to determining at least one encoding parameter based on the analysis result.

28. A device, comprising:
an encoder arranged to encode an input frame portion to provide a currently encoded frame portion, the input frame portion belongs to an input frame;
a memory unit that is arranged to store information about the currently encoded frame portion and about a corresponding previously encoded frame portion, without storing a input frame portion and without storing a portion of a previous frame, wherein the corresponding previously encoded frame portion is generated from the portion of the previous frame; wherein the corresponding previously encoded frame portion is located at a certain location of the previous frame, and wherein the currently encoded frame portion is located at the certain location of the input frame;
a skip circuit that is arranged to:
perform a comparison between information about the currently encoded frame portion and information about the previously encoded frame portion; and
determine, based on a result of the comparison, whether the device shall output the currently encoded frame portion or information indicative of a determination to skip a transmission of the currently encoded frame portion.

29. The device according to claim 28, wherein the skip circuit is arranged to perform a comparison between (i) at least one hash value of the currently encoded frame portion and (ii) at least one hash value of the at least one previously selected frame element.

30. The device according to claim 28, wherein the memory unit is arranged to store hash values of previously encoded frame portions and is prevented from storing previously received input frame portions that were encoded to provide the previously encoded frame portion.

31. The device according to claim 28, comprising an decoder that is arranged to:
partially decode the currently encoded frame portion to provide the information about the currently encoded frame portion; and
partially decode the previously encoded frame portion to provide the information about the previously encoded frame portion.

32. The device according to claim 31, wherein the decoder is arranged to partially decode the currently encoded frame portion to provide a frequency domain representation of the currently encoded frame portion.

33. The device according to claim 28, comprising an decoder that is arranged to:
fully decode the currently encoded frame portion to provide the information about the current set; and
fully decode the previously encoded frame portion to provide the information about the previously encoded frame portion.

34. The device according to claim 28, further arranged to determine whether the output interface should output the currently encoded frame portion or difference information indicative of a difference between the currently encoded frame portion and the previously encoded frame portion.

35. A method for encoding, the method comprises:
applying, by a first encoder, a first type encoding process on an input frame element to provide a first type encoded frame element; the input frame elements belong to an input frame;
applying, by a second encoder, a second type encoding process on the input frame element to provide a second type encoded frame element; wherein the first type encoding process differs from the second type encoding process by a degree of expected loss of data;
selecting, by a control circuit, a selected frame element out of the first and second type encoded frame elements;
storing, by a memory unit, information about the selected frame element; and
outputting the selected frame element.

36. A method for encoding, the method comprises:
encoding, by an encoder, an input frame portion to provide a currently encoded frame portion, the input frame portion belongs to an input frame;
storing, by a memory unit, a previously encoded frame portion without storing a previous frame, wherein the previously encoded frame portion is generated from a portion of the previous frame; wherein the previously encoded frame portion is located at a certain location of the previous frame, and wherein the currently encoded frame portion is located at the certain location of the input frame;
performing, by a skip circuit, a comparison between information about the currently encoded frame portion and information about the previously encoded frame portion; and
determining, based on a result of the comparison, whether the device shall output the currently encoded frame portion or information indicative of a determination to skip a transmission of the currently encoded frame portion.

37. The method according to claim 36, further comprising receiving encoded frame information over a channel, and reconstructing the encoded frame; wherein the reconstructing comprises performing a decoding process while utilizing a memory unit that stores previously received encoded frame elements without storing previously reconstructed frame elements.

38. A method for decoding, the method comprises:
decoding, by an decoder, a received encoded frame element to provide a reconstructed frame element; and
storing, by a memory unit, previously received encoded frame elements without storing the reconstructed frame element or previously decoded reconstructed frame elements.

39. The method according to claim 38, wherein the decoding is responsive to skip information indicative of a determination, by a transmitter, to skip a transmission of a current set of selected frame elements.

40. The method according to claim 38, wherein the decoding is responsive to encoding information that reflects a manner in which the encoded frame element was encoded.

41. The method according to claim 38, wherein the decoding is responsive to encoding information indicative of a type of encoding selected from lossless encoding and lossy encoding.
